(19) United States
(12) Patent Application Publication
(10) Pub. No.: US 2007/0013810 A1
(43) Pub. Date: Jan. 18, 2007

(54) Control of a system for access to teletext information

(75) Inventors: Louis Peter Marie Schreurs, Singapore (SG); Song Khuan Lim, Singapore (SG); Andrew Hun Wee Toh, Singapore (SG); Ah Keow Lim, Singapore (SG); Suresh Babu Kunhutty Vasudevan, Singapore (SG)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., BA Eindhoven (NL)

(21) Appl. No.: 10/558,487

(22) PCT Filed: May 17, 2004
(86) PCT No.: PCT/IB04/50719

§ 371 Date: Nov. 28, 2005

(30) Foreign Application Priority Data
May 27, 2003 (WO) PCT/SG03/00131

(51) Int. Cl. H04N 11/00

(52) U.S. Cl. 348/468

(57) ABSTRACT

A method of controlling a system for providing access to teletext information, comprising, an input for receiving a source signal, a channel selection system for selecting a program channel signal carried by the source signal and including embedded teletext data belonging to a teletext service, a teletext decoder for decoding teletext data embedded in a selected program channel signal, a coder for converting decoded teletext data into a video signal for displaying teletext information on a display device, memory for storing pre-set data including information identifying at least one pre-set program channel signal, an interface for receiving a switch command entered by a user, comprises receiving a switch command through the interface. The method further comprises, in response to the switch command, searching at least a part of decoded teletext data embedded in the pre-set program channel signal for identification information identifying a teletext information provider and directing the system to convert at least part of the decoded teletext data into a video signal if identification information is found corresponding to pre-set identification information included in the pre-set data.

The invention relates to a method of controlling a system for providing access to teletext information, which system comprises,

an input for receiving a source signal,

a channel selection system for selecting a program channel signal carried by the source signal and including embedded teletext data belonging to a teletext service,

a teletext decoder for decoding teletext data embedded in a selected program channel signal,

a coder for converting decoded teletext data into a video signal for displaying teletext information on a display device,

memory for storing pre-set data including information identifying at least one pre-set program channel signal,

an interface for receiving a switch command entered by a user, wherein the method comprises receiving a switch command through the interface.

The invention further relates to a system for providing access to teletext information, comprising,

an input for receiving a source signal,

a channel selection system for selecting a program channel signal carried by the source signal and including embedded teletext data belonging to a teletext service,

a teletext decoder for decoding teletext data embedded in a selected program channel signal,

a coder for converting decoded teletext data into a video signal for displaying teletext information on a display device,

memory for storing pre-set data including information identifying at least one pre-set program channel signal,

an interface for receiving a switch command entered by a user, and a controller for controlling the operation of the system, wherein the system is adapted to decode teletext data embedded in the pre-set program channel signal upon receipt of the switch command.

The invention also relates to video apparatus comprising such a system and to a computer program product.

Examples of a method and system as defined above are known, for example from JP-A-06-030386. This publication discloses a teletext receiver in which a microcomputer generates a table representing a cross reference between four colour keys, a program position (channel) and a page in a storage means. When any of the four colour keys is depressed, a program position and page data corresponding to the depressed colour key are read from the table of the storage means and stored in a RAM of the microcomputer. Then the data of the program position are in use to control channel selection of a tuner. Then page data are fed to a character signal processor to set a page and to automatically receive a teletext program. The content is displayed on a CRT (Cathode Ray Tube).

A problem of the known receiver is that the viewer has no assurance before pressing one of the colour keys, that the page displayed as a result currently contains information targeted at him.

It is an object of the present invention to provide a method, system, computer program and video apparatus of the types defined above that can be used as a means for providing access to proprietary information.

This object is achieved by the method according to the invention, which is characterised by, in response to the switch command, searching at least a part of decoded teletext data embedded in the pre-set program channel signal for identification information identifying a teletext information provider and directing the system to convert at least part of the decoded teletext data into a video signal if identification information is found corresponding to pre-set identification information included in the pre-set data.

Thus, the identification information identifies proprietary information, i.e. information owned by a private individual or corporation and kept up to date for the benefit of a certain audience. The pre-set identification information singles out that certain audience. If proprietary information is currently available for that audience, it is provided to them if they provide the switch command.

Preferably, the method comprises, if no corresponding identification information is found, directing the channel selection system to select at least one further pre-set program channel signal including embedded teletext data, and searching at least a part of the teletext data embedded in each further program channel signal for identification information identifying a teletext information provider and directing the system to decode and convert at least part of the teletext data into a video signal if identification information is found corresponding to the pre-set identification information.

Thus, providers of proprietary information are not limited to one channel. The users of the system controlled by means of this embodiment of the method can be provided with access to a selected number of different sources of proprietary information.

A preferred variant of this embodiment comprises comprising, if identification information is found in teletext data embedded in a further program channel signal, storing information identifying the further program channel signal as starting channel information, and preferably, in response to a second switch command, directing the channel selection system to first select the program channel signal identified by the starting channel information, searching at least a part of the teletext data embedded in the identified program channel signal for identification information identifying a teletext information provider and directing the system to decode and convert at least part of the teletext data into a video signal if identification information is found corresponding to the pre-set identification information. Thus, the second time a user requests access to the proprietary information, assuming it is still transmitted embedded in the same program channel signal, it can be accessed much more quickly, since the first program channel signal selected is already the correct one.

In a preferred embodiment, wherein the system comprises an input for receiving at least one further source signal, the method comprises, upon receipt of the switch signal, directing the system to provide the source signal carrying the pre-set program signal to the channel selection system.

This is a particularly advantageous implementation of the method, as it allows the user quick access to the proprietary information in an environment that would otherwise require many actions on the part of the user, namely selection of the appropriate source, channel and page range in accordance with up-to-date information which must be at hand to the user.

A preferred embodiment comprises directing the system to decode and convert into a video signal teletext data encoding a range of at least one teletext page, in accordance with pre-set page identification data stored in memory.

Thus, the proprietary information can be reserved for a number of dedicated pages within the teletext service. In addition, this embodiment has the advantage that it is not necessary to provide each of the pages containing the proprietary data with the identification information. Instead, separately transmitted identification information indicates to the system that pages containing updated proprietary information are present within the pre-set range.

According to another aspect of the invention, the system according to the invention is characterised in that the system is adapted to be controlled by the controller by means of a method according to the invention.

Thus, the advantages of the method according to the invention are provided and no external means of control are needed to carry out the method.

According to another aspect of the invention, there is provided video apparatus comprising a system according to the invention.

According to a further aspect of the invention, there is provided a computer program product that, when running on a computing device, is capable of enabling the computer device to carry out a method according to the invention.

The invention will now be explained in further detail with reference to the accompanying drawings, of which:

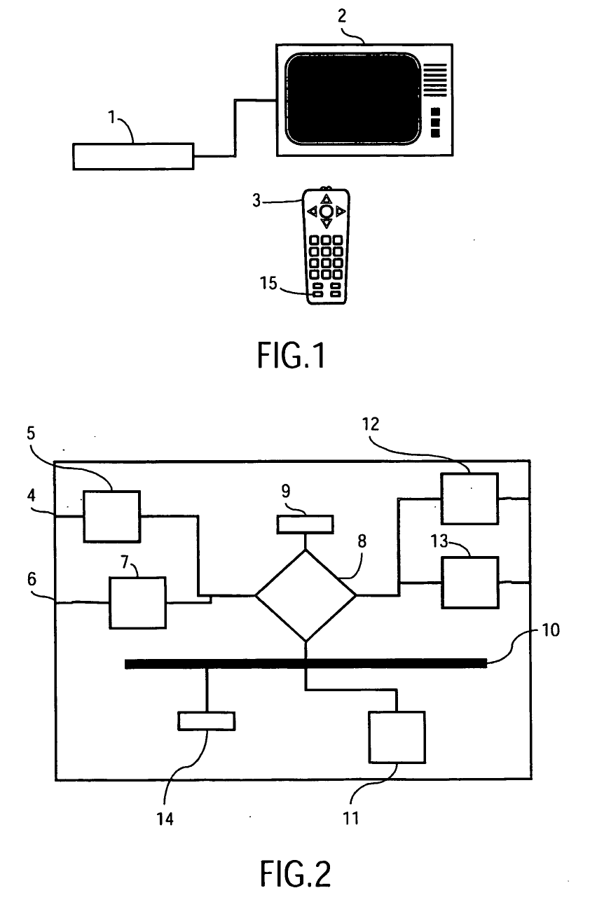

FIG. 1 gives a schematic overview at a component level of a system for providing access to teletext information operating in accordance with the invention;

FIG. 2 is a flow chart of an embodiment of a method implementing the invention;

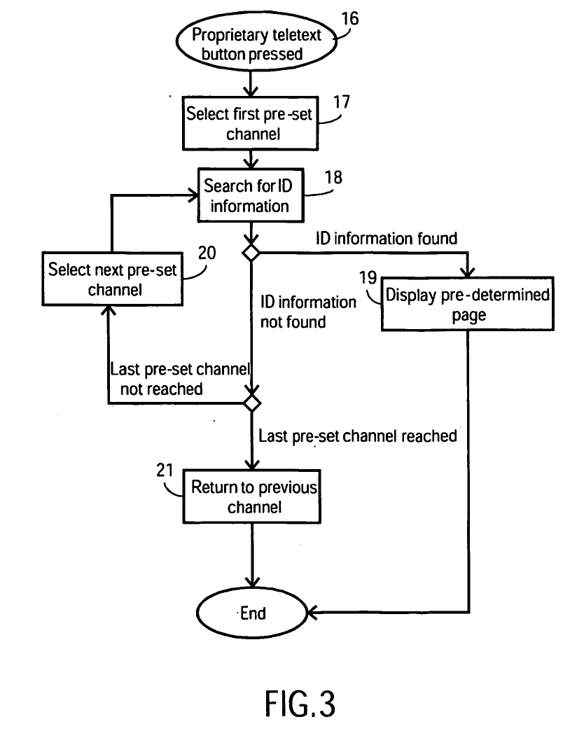

FIG. 3 shows schematically some examples of apparatus employing the invention.

Two examples of video apparatus that could comprise the system of the invention are given in FIG. 1. A DVD (Digital Versatile Disk)-recorder 1 is connected to a television set 2 by means of an analogue video link. Another suitable piece of video apparatus would be a set-top box. In the example to be described below, it will be assumed that the invention is implemented in the television set 2. It is noted that the system for providing access to teletext information need not be comprised in one discrete piece of apparatus, but could comprise distributed components. An example of such an implementation is a personal computer with a separate (possibly external) television tuner connected to a separate board in the computer, with a teletext decoder chip being fitted to the board, or with a software teletext decoder being installed on the computer. In an alternative implementation of the invention, this system could be controlled by software running on the personal computer and directing the operation of each of the aforementioned components making up the system for providing access to teletext information.

Returning to the example of FIG. 1, the television set 2 is controlled by the user by means of a remote control unit 3. Although not necessary for the invention, it will be assumed herein that the television set 2 is a digital television set. An example of a reference design for a digital television is given in FIG. 2.

The digital television set 2 comprises an input 4 for a digital television signal, provided, for example by means of a cable, satellite or terrestrial digital broadcast. The signal may conform to the ATSC or DVB standards, for example. A tuner 5 is used to tune to a broadcast signal of a certain carrier frequency and to extract an MPEG transport stream. The MPEG transport stream is a multiplex of a number of elementary streams, of which a number form a program channel signal.

The digital television set 2 can also accept an analogue video signal from another source, for example a video recorder or an analogue television tuner, through an analogue input 6. The analogue signal is passed to a video decoder 7, capable of handling video in one or more of the known analogue video formats, e.g. PAL, NTSC or SECAM.

A home entertainment engine 8 processes the incoming transport stream signals or converted analogue video signals. In addition, the home entertainment engine 8 controls the operation of the various components of the system. Where the incoming MPEG transport stream comprises a number of program channel signals, it also selects the appropriate one by de-multiplexing the transport stream. The home entertainment engine further comprises a teletext decoder for decoding teletext data embedded in a program channel signal, i.e. in the signal received from the video decoder 7 or comprised in an elementary stream of a bouquet of streams forming a program channel signal and received from the tuner 5.

The home entertainment engine 8 is connected to random access memory (RAM) 9 through a dedicated interface and to a system bus 10 through another interface. Also connected to the system bus 10 is an interface unit 11, for accepting and converting commands entered by the user by means of the remote control unit 3 (FIG. 1).

The home entertainment engine provides an output signal to a video encoder 12, which converts the output signal into a video signal in a format suitable for a display device. This may be an RGB-composite signal for the cathode ray tube of the television set 2. In alternative embodiments, the term video signal can refer to an MPEG-2 signal for a computer attached to a monitor, for example. Audio signals are provided by means of an audio encoder 13.

It is noted that the home entertainment engine may have access to other memory devices than the RAM 9, for example an EEPROM 14, through the system bus 10.

According to the invention, a viewer can watch a program on the television set 2, or a general teletext page, and switch to receiving proprietary information by entering a single switch command. Preferably, the command is entered by pressing one single dedicated key 15 on the remote control unit 3. In this context, proprietary information means information targeted at a specific part of the audience, for example subscribers. One convenient example concerns the provision of up-to-date coverage of sports matches, such as games of cricket. Whilst watching another program, for example a film, the subscribers to the proprietary information can switch to receiving an updated score by pressing just the one dedicated key 15.

The switch command is passed by the interface unit 11 to the home entertainment engine 8 through the system bus 10. In response, the home entertainment engine executes an algorithm shown schematically in FIG. 3.

After receiving the switch command at step 16, the home entertainment engine 8 consults pre-set data stored in the EEPROM 14. The pre-set data includes an entry comprising information identifying a program channel signal, a range of one or more pages on which proprietary information is being transmitted and identification information uniquely identifying the provider of the proprietary information.

If a video is being viewed when the switch command is issued, the system will first be directed to switch to receiving a source signal from the digital input 4, rather than the analogue input 6. Then, the tuner 5 will be directed to tune to the correct MPEG transport stream and the home entertainment engine will ensure that the de-multiplexing mechanism it contains extracts the program elementary streams belonging to the pre-set program channel. These streams form a program channel signal from which embedded teletext data is extracted and decoded. Thus, a first pre-set channel is selected in step 17. It is noted that if the proprietary information retrieval facility is being used for the first time, the first pre-set channel may simply be the channel that is selected when a key marked ‘1’ on the remote control unit 3 is pressed. In other cases, the first pre-set channel is preferably the channel on which the proprietary information has previously been found. In an alternative embodiment, the first pre-set channel may have been specially programmed by the user of the digital television set 2, or factory-programmed.

In step 18, the home entertainment engine receives part of the decoded teletext data and searches it for identification information corresponding to the pre-set identification information stored in the EEPROM 14. The identification may be included in the headers for the pages identified in the pre-set data Alternatively, the identification may be a code in a dedicated packet independent of a particular page, such as packet 8/30 as defined by European Telecommunication Standard ETS 300 707. The latter variant has the advantage that the data in the pages is limited to the proprietary information.

If the identification information is found in step 18, then the home entertainment engine 8 consults the pre-set data stored in the EEPROM 14 to retrieve the information identifying a range of one or more teletext pages in which the proprietary information has been inserted. The teletext decoder is directed to decode these pages. The decoded teletext information is provided to the video encoder 12, for output on the screen of the television set 2, in step 19. Preferably, the proprietary information is included in pages outside the range normally accessible. This means that the pages containing proprietary information will be in the hexadecimal range, e.g. 10A-10E, 20A-200E, 30A-30E, since the keys on the remote control unit only allow to enter numbers in the range 100-109, for example.

If the identification information is not found, then the home entertainment engine will direct the tuner 5 and de-multiplexing mechanism to select a further pre-set channel program signal in step 20, and repeat step 18. If all pre-set channels have been searched, the algorithm proceeds to step 21, in which the channel being watched before the switch command was received is displayed again. This marks the end of the algorithm.

Preferably, if proprietary information is found on a channel selected in step 20, information identifying this channel is stored. Thus, the second time the switch command is entered, the channel identified by this information will be selected first in step 17.

An alternative embodiment is also feasible, in which, after step 19, the user may press a further key, for example an ‘up’ or ‘down’ key, to select a further pre-set channel, which is then searched in a step similar to step 18.

It should be noted that the above-mentioned embodiment illustrates rather than limits the invention, and that those skilled in the art will be able to design many alternative embodiments without departing from the scope of the appended claims. In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. The invention can be implemented by means of hardware comprising several distinct elements, and by means of a suitably programmed computer. In the device claim enumerating several means, several of these means can be embodied by one and the same item of hardware. The mere fact that certain measures are recited in mutually different dependent claims does not indicate that a combination of these measures cannot be used to advantage.

1. Method of controlling a system for providing access to teletext information, comprising:
receiving a source signal,
selecting a program channel signal carried by the source signal and including embedded teletext data belonging to a teletext service,
decoding the teletext data embedded in the selected program channel signal,
converting the decoded teletext data into a video signal for displaying teletext information, storing pre-set data including information identifying at least one pre-set program channel signal,
receiving a switch, searching at least a part of the decoded teletext data embedded in the pre-set program channel signal for identification information identifying a teletext information provider and converting at least part of the decoded teletext data into a video signal if identification information is found corresponding to pre-set identification information included in the pre-set data.

2. Method according to claim 1, comprising, if no corresponding identification information is found, selecting at least one further pre-set program channel signal including embedded teletext data, and searching at least a part of the teletext data embedded in each further program channel signal for the identification information identifying a teletext information provider and decoding and converting at least part of the teletext data into a video signal if identification information is found corresponding to the pre-set identification information.

3. Method according to claim 2, comprising, if identification information is found in teletext data embedded in a further program channel signal, storing information identifying the further program channel signal as starting channel information.

4. Method according to claim 3, comprising, in response to a second switch command, selecting the program channel signal identified by the starting channel information, searching at least a part of the teletext data embedded in the identified program channel signal for identification information identifying a teletext information provider and decoding and converting at least part of the teletext data into a video signal if identification information is found corresponding to the pre-set identification information.

5. Method according to claim 1, wherein the method comprises, upon receipt of the switch signal, providing the source signal carrying the pre-set program signal.

6. Method according to claim 1, comprising decoding and converting into a video signal teletext data encoding a range of at least one teletext page, in accordance with pre-set page identification data stored in a memory.

7. Video apparatus for providing access to teletext information, comprising
an input for receiving a source signal;
a channel selection system for selecting a program channel signal carried by the source signal and including embedded teletext data belonging to a teletext service;
a teletext decoder for decoding teletext data embedded in a selected program channel signal;
a coder for converting decoded teletext data into a video signal for displaying teletext information on a display device;
memory for storing pre-set data including information identifying at least one pre-set program channel signal;
an interface for receiving a switch command entered by a user; and
a controller for controlling the operation of the video apparatus adapted to decode teletext data embedded in the pre-set program channel signal upon receipt of the switch command.

8. System for providing access to teletext information, comprising:
an input for receiving a source signal;
a channel selection system for selecting a program channel signal carried by the source signal and including embedded teletext data belonging to a teletext service;
a teletext decoder for decoding teletext data embedded in a selected program channel signal;
a coder for converting decoded teletext data into a video signal for displaying teletext information on a display device;
memory for storing pre-set data including information identifying at least one pre-set program channel signal;
an interface for receiving a switch command entered by a user; and
a controller for controlling the operation of the system, wherein the system is adapted to decode teletext data embedded in the pre-set program channel signal upon receipt of the switch command.

9. A computer readable storage medium containing a program which causes a processor to perform a method comprising:
receiving a source signal;
selecting a program channel signal carried by the source signal and including embedded teletext data belonging to a teletext service;
decoding the teletext data embedded in the selected program channel signal;
converting the decoded teletext data into a video signal for displaying teletext information;
storing pre-set data including information identifying at least one pre-set program channel signal;
receiving a switch command;
searching at least a part of the decoded teletext data embedded in the pre-set program channel signal for identification information identifying a teletext information provider; and
converting at least part of the decoded teletext data into a video signal if the identification information is found corresponding to pre-set identification information included in the pre-set data.
